(19) United States
(12) Patent Application Publication
(10) Pub. No.: US 2007/0237534 A1
(43) Pub. Date: Oct. 11, 2007

(54) Dot Gain And Color Linearization Dual Calibration

(76) Inventors: Shlomo Harush, Nes-Ziona (IL); Gregory Braverman, Hertzelia (IL); Eyal Shelef, Tel-Aviv (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,607

(22) Filed: Apr. 27, 2007

(30) Foreign Application Priority Data
Oct. 28, 2004 (IL) PCT/IL04/00988

(51) Int. Cl. G03G 15/00; G03G 15/043; G03G 15/06

(52) U.S. Cl. 399/49; 399/51; 399/55

(57) ABSTRACT

A method of calibrating an electrographic printer, comprising: a) producing a latent image of a banded test pattern and a solid test pattern, using a beam of a light source of controllable power; b) developing the banded test pattern and the solid test pattern with a toner, utilizing an electrode with a developing voltage; c) measuring an average toner optical density of the developed banded test pattern and an average optical toner density of the developed solid test pattern; and d) adjusting one or both of (i) the developing voltage and (ii) the power and/or the diameter of the beam such that the measured average toner optical density of the two patterns matches, within predetermined limits, desired optical densities.

### FIELD OF THE INVENTION

The field of the invention is electrographic printers.

### BACKGROUND OF THE INVENTION

In electrographic printers, a modulated light source, typically a laser, scans the charged surface of a photosensitive cylinder to produce a latent image from a digital image file, by discharging parts of the surface. After the discharge, regions that are intended to receive toner are at a first voltage, and background regions are at a second voltage. Regions that are intended to be of intermediate apparent optical density are typically produced by using half-tone patterns in the digital image file, so that each location on the photosensitive cylinder is either at the first voltage or the second voltage. The latent image is then developed by exposing the surface to an electrographic toner, in the presence of an electrode which typically has a developer voltage between the first and second voltage, so that the sign of the electric field differs for regions at the first voltage and at the second voltage. The toner contains charged particles which are attracted to the photosensitive surface in the regions where the surface is at the first voltage, and repelled from the regions where the surface is at the second voltage.

In some prior art systems, such as for example that described in U.S. Pat. No. 5,864,353 to Gila et al, the disclosure of which is incorporated herein by reference, the dot configuration for half toning is defined using a two part process. In a first part, a dot density and size is defined by varying the laser power and development voltage.

The actual dots in the half-tone patterns are typically not equal in size and shape to the square dots defined in the digital image file, with the ratio in dot area coverage, the “dot gain,” being in general a nonlinear function of the average density and shape of the half-tone pattern in that region. The reasons for dot gain include the finite effective width of the laser beam (i.e. the width of the area where the beam is intense enough to discharge the surface), and the spreading out of toner on the photosensitive cylinder or on an intermediate transfer member or during transfer between surfaces. The dot gain for various pixel half tone configurations is typically compensated for by modifying the digital image file using a look-up table (LUT) (second part) which gives the actual density as a function of digital file half-tone area, so that the image has the desired toner coverage in each region. However, the dot gain changes with time, due to aging of components or changing environmental conditions for example, so the printer must be recalibrated periodically.

In the US patent to Gila et al, the two part method provides a method of calibrating an electrographic printer to compensate for changes in dot size and density, without the need to recalculate the LUT each time. Two test patterns are used. The first pattern is solidly covered with toner, and the second pattern is a 50% half-tone pattern. (Other half-tone test patterns may also be used, and a 75% half-tone test pattern is used in a number of printers made by Hewlett-Packard.) First, the developer voltage is adjusted so that the solid pattern has the desired toner optical density. Then, the laser power (which also affects the laser beam width) is adjusted so that the half- tone pattern has the desired density. Optionally, the procedure is iterated. It was found that this procedure resulted in accurate toner densities for half-tone patterns of other densities (greater than or less than 50%) as well, without making any change in the LUT.

U.S. Pat. No. 4,680,646 to Ikeda et al, the disclosure of which is incorporated herein by reference, describes the use of different arrangements of dots in half-tone patterns for use as test patches for calibration, including an arrangement like the 50% half-tone pattern shown in FIG. 5 of this application.

### SUMMARY OF THE INVENTION

An aspect of some embodiments of the invention concerns an electrographic printer in which the test pattern used to adjust the power of the laser (or other light source) is not a 50% half-tone pattern used as a test pattern in the prior art, such as the patterns shown in FIGS. 4 and 5, but is a pattern consisting of alternating bands of solid toner and no toner, each band generally no more than ten dots wide, and typically only one or a few dots wide.

The present inventors have found that when the two part method of Gila et al. is used with high coverage values such as 50% or 75%, the look-up table can go out of calibration after a few days. The present inventors believe that this is caused by the fact that the measurements made in the first part of the method are not very sensitive to the dot size, while the look-up table for low gray level density values are increasingly more sensitive as the gray level density is reduced. Furthermore, it was found that when the first step is performed, there are changes in the width of the lines in small fonts and line work. In practice, it is desirable to redo the generation of the look-up tables whenever the first step in the method is performed.

The present method of using bands as the measure for calibrating in the first step of Gila provides improved stability for both low density gray level values and also provides for repeatable fonts and line-work as the first step of calibration is performed. For example, in an embodiment of the invention, the pattern consists of bands (lines) of solid toner that are two dots wide, alternating with bands of no toner that are three dots wide. The average density of toner in such a pattern is more reliably correlated with the effective width of the laser beam (i.e. the width of the region over which the photosensitive surface is effectively discharged by the laser during one scan across the surface) than is the average density of toner in a prior art half-tone test pattern.

As in Gila et al, a solid test pattern is still used to adjust the developer voltage and laser power, and a LUT is used to adjust the half-tone densities in the digital image file. The resulting images are still just as good in regions of mid and high half- tone density as when the procedure of Gila et al is used. However, as indicated above, while the procedure of Gila, et al., does give good values for mid and high gray levels, it does not always give stable line widths for thin lines, such as bar codes, text with small font size, or hand-drawn lithographs or other images with fine lines, or stable low gray level values. Utilizing thin bands for calibration of dot size enables better control over the dot size, due to the increased sensitivity of the calibration to the dot size, resulting in more repeatable values for low gray level values, fine line-work and small or thin fonts.

There is thus provided, in accordance with an embodiment of the invention, a method of calibrating an electrographic printer, comprising:

a) producing a latent image of a banded test pattern and a solid test pattern, using a beam of a light source of controllable power;

b) developing the banded test pattern and the solid test pattern with a toner, utilizing an electrode with a developing voltage;

c) measuring an average toner optical density of the developed banded test pattern and an average optical toner density of the developed solid test pattern; and

d) adjusting one or both of (i) the developing voltage and (ii) the power and/or the diameter of the beam such that the measured average toner optical density of the two patterns matches, within predetermined limits, desired optical densities.

In an embodiment of the invention, the developing voltage is adjusted in a direction so as to increase the toner optical density of the developed solid test pattern if the measured average toner optical density of the solid test pattern is lower than a target toner optical density for the solid test pattern, and so as to decrease the toner optical density of the developed solid test pattern if the measured average toner optical density of the developed solid test pattern is higher than the target toner optical density for the solid test pattern; and including

e) adjusting one or both of the power of the light source and an effective width of the beam, in a direction so as to increase the toner optical density of the developed banded test pattern if the measured average toner optical density of the banded test pattern is lower than a target toner optical density for the banded test pattern, and so as to decrease the toner optical density of the developed banded test pattern if the measured average toner optical density of the developed banded test pattern is higher than the target toner optical density for the banded test pattern.

In an embodiment of the invention, more than half of the area of the banded test pattern comprises bands with substantially full toner density alternating with bands with substantially no toner.

In an embodiment of the invention, more than half of the area of the banded test pattern comprises bands with substantially full toner density alternating with bands with substantially no toner, each band less than ten dots wide.

In an embodiment of the invention, the area of the banded test pattern comprises bands with substantially full toner density alternating with bands with substantially no toner, each band between one and five dots wide.

Optionally, each band is between one and three dots wide.

In an embodiment of the invention, the area of the banded test pattern comprises bands with substantially full toner density alternating with bands with substantially no toner, the bands with full toner comprising between 20% and 60% of the area of the banded test pattern.

There is further provided, in accordance with an embodiment of the invention, a method of electro graphic printing comprising:

a) calibrating the printer according to an embodiment of the invention;

b) producing a latent image on the photosensitive cylinder, using the beam of the light source;

c) developing the latent image with the toner, utilizing the electrode at the developing voltage; and

d) transferring the developed latent image directly or indirectly to a printing medium.

Optionally, producing the latent image comprises using a digital image file in which a plurality of brightness levels have been adjusted in a manner which compensates for a nonlinear relationship between digital coverage levels and printed toner densities corresponding to the coverage levels.

Optionally, (a) through (d) are repeated for a plurality of toners of different colors, the developed latent image for each color of toner comprises a color separation for that color, and the color separations are printed in substantial alignment on a single printing medium, thereby producing a color printed image.

### BRIEF DESCRIPTION OF THE DRAWINGS

Exemplary embodiments of the invention are described in the following sections with reference to the drawings. The drawings are generally not to scale and the same or similar reference numbers are used for the same or related features on different drawings.

FIG. 1 is a schematic perspective view of an electrographic printer, according to an exemplary embodiment of the invention;

FIG. 2 is a flow chart of a procedure for calibrating the printer shown in FIG. 1;

FIG. 3 is a more detailed schematic view of a test pattern shown in FIG. 1; and

FIGS. 4 and 5 are schematic views of a different calibration test patterns used in the prior art.

### DETAILED DESCRIPTION OF EXEMPLARY EMBODIMENTS

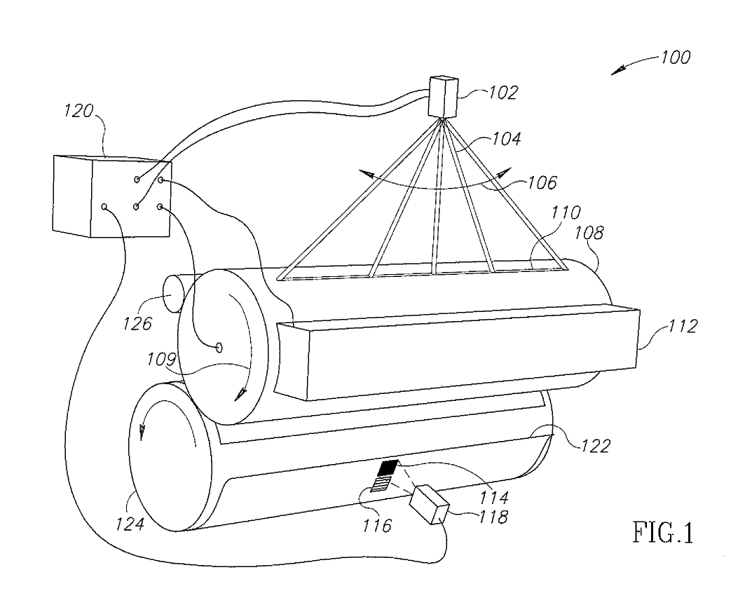

FIG. 1 shows an electrographic printer 100. A light source 102 produces a beam 104, for example from a laser, which swings back and forth, as indicated by arc 106, thereby scanning the surface of a charged photosensitive cylinder 108, along a line 110, and locally discharging the surface when the laser beam is turned on. The scanning is performed, for example, by a mirror, not shown, in light source 102, which rotates or swings back and forth while the beam reflects from it. Photosensitive cylinder 108 rotates, in a direction indicated by arrow 109. Scanning beam 104 produces a two-dimensional latent image of charged and discharged regions on the surface of photosensitive cylinder 108, by turning on and off, or modulating its power, as the beam scans and the photosensitive cylinder rotates. The latent image is developed into a toner image when the surface passes a development station 1 12.

From time to time printer 100 undergoes a calibration procedure, in which a solid print test pattern 114, and a second test pattern 116, are produced on photosensitive cylinder 108, by producing latent images of the test patterns and developing them with developing station 112. The calibration procedure is optionally done before printing each page, or alternatively at regular intervals of time, or every time the printer is turned on, or whenever initiated manually by the operator of the printer, or at times determined in any other way.

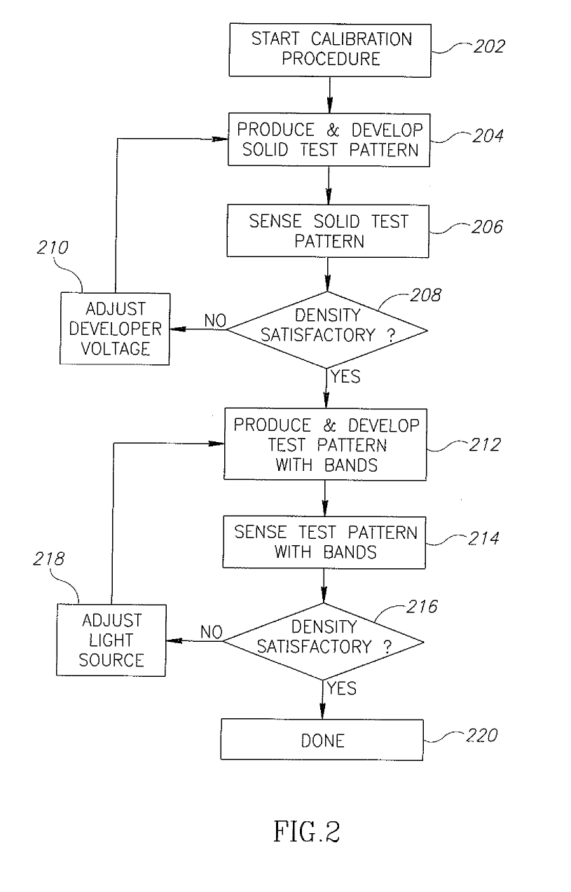

Optionally, the developed images of the test patterns are then transferred to a printing medium 122 on an impression cylinder 124. Alternatively, the developed image is transferred first to an intermediate transfer member, not shown, and then to the printing medium. A sensor 118 measures the average toner optical density of each test pattern on the printing medium, and communicates this information to a controller 120. The controller controls the power of light source 102, as well as controlling a voltage difference between an electrode (not shown) in the developing station, and the surface of photosensitive cylinder 108, as will be described in FIG. 2.

Alternatively, instead of measuring the toner optical density of the test pattern on the printing medium, sensor 118 measures the toner optical density of the developed image directly on the photosensitive cylinder, or on the intermediate transfer member. In this case, the image of the test pattern is optionally not transferred to the printing medium at all. A potential advantage of measuring the toner optical density on the printing medium is that the color of the printing medium can be chosen to contrast well with the toner, for example using a white printing medium if the toner is black, while the properties required of the photosensitive cylinder and the intermediate transfer member may limit the range of possible colors of their surfaces, making it more difficult to distinguish the toner from the background. The printing medium used for measuring the toner optical density of the test pattern need not be the same as the printing media used for regular printing jobs.

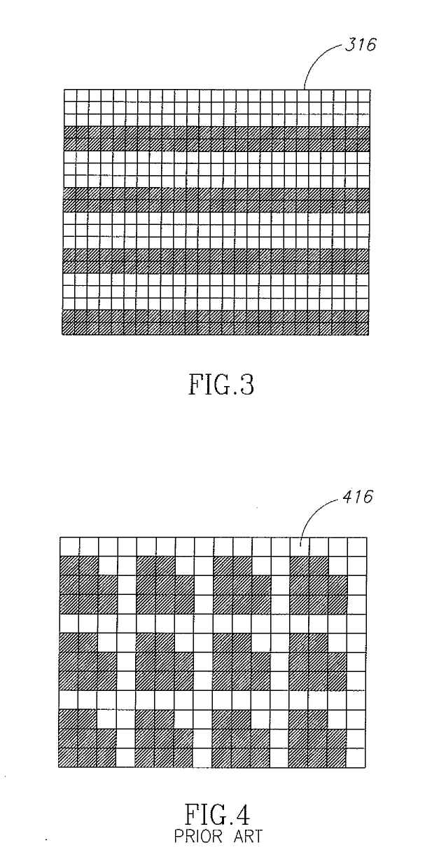

Although many of the features of the printer shown in FIG. 1 and the method shown in FIG. 2 are used also in the prior art, for example by Gila et al, they are described here in some detail in order to explain the invention more clearly. A feature of the invention that differs from the prior art is the arrangement of dots in a test pattern used to calibrate the width of the dot. An example of a calibration pattern, in accordance with an embodiment of the invention is shown as test pattern 116 in FIG. 1, and in more detail in FIG. 3.

Any remaining toner on the surface of photosensitive cylinder 108, either from the test patterns or from regular printing jobs, is cleaned off by cleaning element 126, leaving the surface of photosensitive cylinder 108 ready for the next latent image produced by laser unit 102.

FIG. 2 is a flow chart showing the calibration procedure. The procedure is described for a single color of toner, but optionally, in the case of color printing, the procedure is repeated for each color of toner used. Optionally, the calibration procedure is done for all colors before printing is done, and the controller stores information on the light source power and developing voltage to use with each color of toner. The calibration procedure is particularly useful for color printing, because errors in toner optical density that differ for different color separations are generally more noticeable than errors in toner optical density in monochrome printing.

The procedure is started at 202. At 204, a latent image of the solid test pattern is produced, and developed to form a toner image. The solid test pattern is, for example, in the form of a relatively small rectangle, but much greater in size than a single pixel, with every pixel at a maximum toner density. In 206, an average toner optical density of the solid test pattern is measured with sensor 118, for example by measuring an average reflectivity of the solid test pattern. Optionally, sensor 118 illuminates solid test pattern 114 in a controlled manner, and integrates the light reflecting from solid test pattern 114, or from a substantial portion of test pattern 114.

At 208, the measured solid toner optical density of solid test pattern 114 is compared to a desired solid toner optical density. In general, sensor 118 sends only the measured toner optical density to controller 120 and controller 120 makes the comparison the desired toner optical density. Alternatively sensor 118 sends a digital image file of test values to controller 120, and controller 120 calculates the average solid toner optical density. However, the sensor may be configured to compute the average density or even to compare it to a desired value.

If the measured toner solid optical density of test pattern 114 is too high or too low, then the developer voltage, defined as the voltage difference between the surface of developer cylinder 108 and the electrode in developing station 112, is changed accordingly in 210, and the procedure then returns to 204, with the latent image developed at the new value of the developer voltage. For example, if the toner optical density of the solid test pattern is too low, then the developer voltage is changed in a direction which will increase its magnitude in those regions of the latent image where toner is going to be deposited. This will result in a greater density of toner being deposited on the photosensitive cylinder when a latent image is developed. If the toner optical density is too high, then the voltage is changed in the other direction.

Optionally, the ratio of the measured toner optical density to the desired toner optical density is taken into account, in changing the developer voltage, using any algorithm known in the art of control theory to zero in on the desired toner optical density, taking into account the expected change in toner optical density with changing developer voltage.

Alternatively, only the sign of the difference between the measured toner optical density and the desired toner optical density is taken into account, and the developer voltage is increased or decreased by a fixed amount. Alternatively, the developer voltage is only adjusted once, to a value based on the measured toner optical density and optionally, the rate of change of the density with change in voltage, but the procedure is not repeated.

Optionally, the controller keeps track of the number of times the developer voltage is changed, and stops changing the developer voltage if the number of iterations exceeds some number, if the developer voltage reaches a maximum or minimum value, proceeding to 212, and/or issuing an error message to the operator of the printer and ending the calibration procedure. This might happen for example, if the printer ran out of toner, or if there were some malfunction. The procedure also proceeds to 212 when the measured toner optical density matches the desired toner optical density, within some tolerance, for example within 4%. As used herein, saying that the toner optical densities match within X% means, for example, that if the target toner optical density is 50%, then the measured toner optical density is between (50-X)% and (50+X)%.

At 212, a second test pattern 116, comprising a set of parallel bands (lines), is produced as a latent image, and developed into a toner image. Alternatively, second test pattern 116 is always produced together with solid test pattern 114. In 214, an average toner optical density of test pattern 116 is measured with sensor 118, using any of the methods described above for measuring the average toner optical density of solid test pattern 114. If the two test patterns are always produced together, then optionally sensor 118 produces a digital image of both test patterns, and software, run for example by the controller, is used to calculate the average toner optical density of each test pattern.

If it is decided, in 216, that the measured average toner optical density of test pattern 116 is not close enough to a desired toner optical density, then, depending on whether the measured average toner optical density is greater or less than the desired toner optical density, the power of light source 102 is optionally adjusted by the controller in 218. For example, if the toner is deposited on those portions of the photosensitive cylinder which are discharged by the light source, and the measured average toner optical density is too low, then the power of the light source is increased, while if the measured average toner optical density is too high, then the power of the light source is decreased. If the toner is deposited on those portions of the photosensitive cylinder which are not discharged, then the power of the light source is adjusted in the opposite direction. Any of the control algorithms mentioned above for controlling the developer voltage are also optionally used for controlling the power of the light source. Optionally, the controller stops changing the power of the light source if the number of iterations exceeds some number, and/or if the power reaches a maximum or minimum value, and the controller then proceeds to 220, and/or issues an error message, similar to what was described previously for the developer voltage.

The controller also proceeds to 220 if the toner optical density for test pattern 116, measured in 214, matches the desired toner optical density, to within some tolerance. At 220, the calibration procedure ends.

Increasing the power of light source 102 generally also increases the effective width of beam 104, and the effective size of the spot it makes when it strikes photosensitive cylinder 108. This is true, for example, because at higher light intensity, a larger cross-section of beam 104 has sufficient power per area to discharge the photosensitive surface, and additionally, the FWHM beam width may be greater at higher light source power. Although the toner optical density for the solid test pattern is relatively insensitive to the light source power and the effective width of the beam, the average toner optical density of other patterns of pixels is sensitive to the light source power and effective beam diameter.

Optionally, the width of beam 104 is controllable independently of the power of light source 102, and the controller controls only the beam width, or controls the beam width and the power independently, instead of controlling the beam width only indirectly by controlling the power of the light source, as described above.

FIG. 3 shows a detailed view of a toner pattern 316 that could serve as test pattern 116. In FIG. 3, black indicates full toner density, and white indicates no toner, although the actual color of the toner need not be black. Similarly, the term “gray tones” or “gray levels” is used herein to describe the appearance of regions with toner optical density intermediate between 100% and 0%, even though the toner need not be black. It should be understood that FIG. 3 shows relatively few dots, so that the pattern will be clearly visible, while in the actual test patterns, the pattern shown in FIG. 3, or other patterns as will be described, optionally continues over more dots in length and/or width. Alternatively, the actual test pattern uses fewer dots than shown in FIG. 3. Toner pattern 316 consists of a series of parallel black lines or bands, each two dots wide, separated by white bands that are three dots wide. This pattern has been found to be more closely related to the actual dot size than other test patterns used in the prior art for the purpose of controlling the light source power. It is noted that, ideally, one could use a patterns of single dots without neighbors for the test pattern. The most dense such pattern would be a pattern of 25% dot print. However, as is well known, patterns of single dots or two dots may not transfer reliably. While in regular printing, this phenomena can be partially compensated for, in a calibration set-up it would result in unacceptable errors.

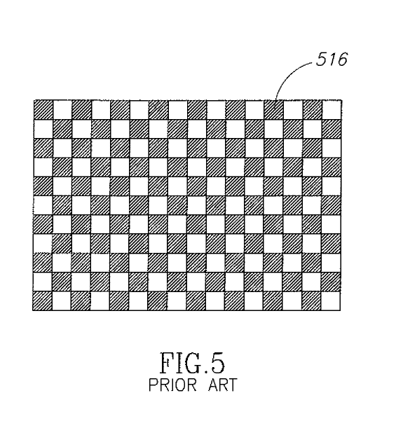

FIG. 4 shows a typical 50% half-tone pattern 416 used in the prior art, for printing an image with 16 brightness levels. Each pixel is a square of 4×4 dots. A 50% brightness level pixel has 8 black dots and 8 white dots. Because isolated black dots (i.e. dots of full toner density, whatever the color of the toner) have a tendency not to transfer reliably from the photosensitive cylinder and hence to be lost in the printed image, the 8 black dots are arranged in a compact group, and this is also true for the other brightness levels.

If the image consists only of regions of fairly uniform brightness level, then a look-up table, with the light source adjusted by calibrating the average toner optical density for the pattern of dots used for one of the intermediate brightness levels such as pattern 416, will do a good job of compensating for dot gain. But if the image is a binary image, with each pixel corresponding to a single dot that is either black or white and with the image including highly non-uniform areas, for example narrow bands that are only one or a few dots wide, then using pattern 416 as a test pattern for adjusting the light source will not give good results. Neither will using a pattern 516 in FIG. 5, a checkerboard pattern of dots for a 50% brightness level which is described for use as a test pattern by Ikeda et al.

Using toner pattern 316, on the other hand, works well both for image regions containing extended fairly uniform gray tones, and highly non-uniform areas. Firstly, the pattern, while still being very sensitive to dot size, transfers much more reliably than single dot patterns. Secondly, it is relatively simple to compute and stabilize the actual dot size from measurements of solid optical density and average optical density of the pattern of FIG. 3. This allows for better control of the dot size than in the prior art.

Alternatively, test pattern 116 uses other patterns consisting of alternating parallel bands of black and white dots, with the black bands and the white each having a width that is a small number of dots, for example less than ten dots, but at least two dots. Alternatively, the black bands or the white bands, or both, are only one dot wide. Optionally, the black bands, or the white bands, or both, are no more than five dots wide, or no more than three dots wide. Optionally, the black bands all have the same width, and the white bands all have the same width. Alternatively, there is a more complicated pattern in which the black bands and/or the white bands are not all the same width. Optionally, the width of the black bands is not too different than the width of the white bands, so that the toner pattern has a dot area not too different from 50%, for example between 40% and 60%. Different dot patterns for test pattern 116 may be appropriate for different types of electrographic printers.

Referring back to FIG. 2, alternatively, instead of ending the procedure once the measured toner optical density of test pattern 116 agrees with the desired toner optical density, control then returns to 204, with solid test pattern 114 produced using the new value for light source power, and the toner optical density of the solid test pattern again measured in 206, and compared to the desired toner optical density for the solid test pattern in 208. If the toner optical density of the solid test pattern is still close to its desired value, then the calibration procedure ends. Otherwise, repeated iterations are made until a developer voltage and a light source power are found for which both the toner optical density of solid test pattern 114 and the toner optical density of test pattern 116 are close to their desired values. Optionally, instead of alternately adjusting the developer voltage and the light source power, there is a single control loop, utilizing measured values of the toner densities of both test patterns to adjust both the developer voltage and the light source power. For example, as described by Gila et al. using a different half-tone test pattern, partial derivatives of the two test pattern toner densities are found with respect to the two control variables, developer voltage and light source power, and two simultaneous linear equations are solved to find the values of the control variables that are expected to give the desired toner densities for the two test patterns.

The procedure is then optionally iterated until the measured toner densities match the desired toner densities within the tolerances. Alternative methods of zeroing in on the desired toner densities of the two test patterns will be apparent to those skilled in the art of multivariable control theory.

It should be noted that while the above discussion has utilized the various methods of calibrating for dot size and density as defined in Gila, et al., the test patterns that are described herein can also be used to replace the calibration patterns in other prior art calibration methods.

Test pattern 116 is optionally used also for calibrating printers, even those that are not electrographic printers, using control variables other than developer voltage and light source power.

Once the calibration has been completed, optionally for each color of toner in the case of color printing, light source 102 begins producing a latent image on photosensitive cylinder 108, for a printing job. Optionally the latent image is based on a digital image file for which brightness levels have been modified according to a look-up table, to correct for the nonlinear effects of finite effective beam width, as described, for example, in Gila et al. and in other references.

The invention has been described in the context of the best mode for carrying it out. It should be understood that not all features shown in the drawings or described in the associated text may be present in an actual device, in accordance with some embodiments of the invention. Furthermore, variations on the method and apparatus shown are included within the scope of the invention, which is limited only by the claims. The words “comprise”, “include” and their conjugates as used herein mean “include but are not necessarily limited to”. Unless specified otherwise, “beam width” as used herein means the full width at half maximum intensity.

1. A method of calibrating an electrographic printer, comprising:
a) producing a latent image of a banded test pattern and a solid test pattern, using a beam of a light source of controllable power;
b) developing the banded test pattern and the solid test pattern with a toner, utilizing an electrode with a developing voltage;
c) measuring an average toner optical density of the developed banded test pattern and an average optical toner density of the developed solid test pattern;
d) adjusting one or both of (i) the developing voltage and (ii) the power and/or the diameter of the beam such that the measured average toner optical density of the two patterns matches, within predetermined limits, desired optical densities.

2. A method according to claim 1 wherein the developing voltage is adjusted in a direction so as to increase the toner optical density of the developed solid test pattern if the measured average toner optical density of the solid test pattern is lower than a target toner optical density for the solid test pattern, and so as to decrease the toner optical density of the developed solid test pattern if the measured average toner optical density of the developed solid test pattern is higher than the target toner optical density for the solid test pattern; and including
e) adjusting one or both of the power of the light source and an effective width of the beam, in a direction so as to increase the toner optical density of the developed banded test pattern if the measured average toner optical density of the banded test pattern is lower than a target toner optical density for the banded test pattern, and so as to decrease the toner optical density of the developed banded test pattern if the measured average toner optical density of the developed banded test pattern is higher than the target toner optical density for the banded test pattern.

3. A method according to claim 1, wherein more than half of the area of the banded test pattern comprises bands with substantially full toner density alternating with bands with substantially no toner.

4. A method according to claim 3, wherein more than half of the area of the banded test pattern comprises bands with substantially full toner density alternating with bands with substantially no toner, each band less than ten dots wide.

5. A method according to claim 4, wherein the area of the banded test pattern comprises bands with substantially full toner density alternating with bands with no substantially no toner, each band between one and five dots wide.

6. A method according to claim 5, wherein each band is between one and three dots wide.

7. A method according to claim 1, wherein the area of the banded test pattern comprises bands with substantially full toner density alternating with bands with substantially no toner, the bands with full toner comprising between 20% and 60% of the area of the banded test pattern.

8. A method of electrographic printing comprising:
a) calibrating the printer according to claim 1;
b) producing a latent image on the photosensitive cylinder, using the beam of the light source;
c) developing the latent image with the toner, utilizing the electrode at the developing voltage;
d) transferring the developed latent image directly or indirectly to a printing medium.

9. A method according to claim 8, wherein producing the latent image comprises using a digital image file in which a plurality of brightness levels have been adjusted in a manner which compensates for a nonlinear relationship between digital coverage levels and printed toner densities corresponding to the coverage levels.

10. A method according to claim 9, wherein (a) through (d) are repeated for a plurality of toners of different colors, the developed latent image for each color of toner comprises a color separation for that color, and the color separations are printed in substantial alignment on a single printing medium, thereby producing a color printed image.

11. A method according to claim 2, wherein more than half of the area of the banded test pattern comprises bands with substantially full toner density alternating with bands with substantially no toner.

12. A method according to claim 11, wherein more than half of the area of the banded test pattern comprises bands with substantially full toner density alternating with bands with substantially no toner, each band less than ten dots wide.

13. A method according to claim 12, wherein the area of the banded test pattern comprises bands with substantially full toner density alternating with bands with no substantially no toner, each band between one and five dots wide.

14. A method according to claim 13, wherein each band is between one and three dots wide.

15. A method according to claim 2, wherein the area of the banded test pattern comprises bands with substantially full toner density alternating with bands with substantially no toner, the bands with full toner comprising between 20% and 60% of the area of the banded test pattern.

16. A method of electrographic printing comprising:
a) calibrating the printer according to claim 2;
b) producing a latent image on the photosensitive cylinder, using the beam of the light source;
c) developing the latent image with the toner, utilizing the electrode at the developing voltage;
d) transferring the developed latent image directly or indirectly to a printing medium.

17. A method according to claim 16, wherein producing the latent image comprises using a digital image file in which a plurality of brightness levels have been adjusted in a manner which compensates for a nonlinear relationship between digital coverage levels and printed toner densities corresponding to the coverage levels.

18. A method according to claim 8, wherein (a) through (d) are repeated for a plurality of toners of different colors, the developed latent image for each color of toner comprises a color separation for that color, and the color separations are printed in substantial alignment on a single printing medium, thereby producing a color printed image.

19. A method according to claim 17, wherein (a) through (d) are repeated for a plurality of toners of different colors, the developed latent image for each color of toner comprises a color separation for that color, and the color separations are printed in substantial alignment on a single printing medium, thereby producing a color printed image.

20. A method according to claim 16, wherein the area of the banded test pattern comprises bands with substantially full toner density alternating with bands with substantially no toner, the bands with full toner comprising between 20% and 60% of the area of the banded test pattern.
